(19) United States
(12) Patent Application Publication
(10) Pub. No.: US 2026/0227496 A1
(43) Pub. Date: Aug. 6, 2026

(54) SYSTEMS, METHODS, AND APPARATUS FOR DISCRETE-TIME COHERENT RANGING

(71) Applicant: The General Hospital Corporation, Boston, MA (US)

(72) Inventors: Benjamin Vakoc, Boston, MA (US); Yongjoo Kim, Boston, MA (US); Norman Lippok, Somerville, MA (US)

(21) Appl. No.: 19/150,883

(22) PCT Filed: Jan. 26, 2024
(86) PCT No.: PCT/US2024/013119

§ 371 Date: Jul. 24, 2025

Related U.S. Application Data
(60) Provisional application No. 63/481,829, filed on Jan. 27, 2023.

(51) Int. Cl. G01S 7/4865; G01S 7/499; G01S 17/10

(52) U.S. Cl. CPC G01S 7/4865; G01S 7/499; G01S 17/10

(57) ABSTRACT

A coherent ranging system, including: an electromagnetic radiation source; a detector; and optics including a sample arm and a reference arm, the electromagnetic radiation source configured to generate a plurality of optical pulses and transmit the plurality of optical pulses toward the sample arm and the reference arm, and the detector configured to receive electromagnetic radiation returned from the sample arm and the reference arm and to generate a plurality of values based on an optical energy of each of the plurality of optical pulses of the electromagnetic radiation returned from the sample arm and the reference arm, each value of the plurality of values corresponding to a respective optical pulse of the plurality of optical pulses.

### CROSS-REFERENCE TO RELATED APPLICATIONS

The present application is based on and claims priority from U.S. Patent Application Ser. No. 63/481,829, filed on Jan. 27, 2023, the entire disclosure of which is incorporated herein by reference.

### STATEMENT REGARDING FEDERALLY SPONSORED RESEARCH

N/A

### BACKGROUND

Coherent optical ranging uses interferometry to measure the positional information of a sample. It is used within numerous fields, including lidar, inspection, and imaging (e.g., optical coherence tomography). Traditionally, coherent ranging systems have used an optical source that emits an electromagnetic field with a wavelength that either (i) does not change over time (such as a broadband optical light source) or (ii) varies continuously over time (such as a wavelength-swept laser). However, current systems that are designed for use with these sources have deficiencies when used with sources that emit an electromagnetic radiation field with discontinuous, otherwise known as discrete-time, tuning of wavelength.

### SUMMARY OF THE DISCLOSURE

Accordingly, new systems, methods, and media for discrete-time coherent ranging are desirable.

In one aspect, a coherent ranging system is provided. The system includes: an electromagnetic radiation source; a detector; and optics including a sample arm and a reference arm, the electromagnetic radiation source configured to generate a plurality of optical pulses and transmit the plurality of optical pulses toward the sample arm and the reference arm, and the detector configured to receive electromagnetic radiation returned from the sample arm and the reference arm and to generate a plurality of values based on an optical energy of each of the plurality of optical pulses of the electromagnetic radiation returned from the sample arm and the reference arm, each value of the plurality of values corresponding to a respective optical pulse of the plurality of optical pulses.

In another aspect, a method for coherent ranging is provided. The method includes: providing an electromagnetic radiation source, a detector, and optics including a sample arm and a reference arm; generating, using the electromagnetic radiation source, a plurality of optical pulses and transmitting the plurality of optical pulses toward the sample arm and the reference arm; receiving, using the detector, electromagnetic radiation returned from the sample arm and the reference arm; and generating, using a processor coupled to the detector, a plurality of values based on an optical energy of each of the plurality of optical pulses of the electromagnetic radiation returned from the sample arm and the reference arm, each value of the plurality of values corresponding to a respective optical pulse of the plurality of optical pulses.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows a diagram of an exemplary discrete-time coherent ranging system according to the disclosure.

FIGS. 2A and 2B show exemplary discrete-time optical signals that would be generated by the electromagnetic radiation source in FIG. 1.

FIGS. 3A, 3B, and 3C show examples of different pulse shapes for the discrete-time optical signal generated by the electromagnetic radiation source of FIG. 1.

FIGS. 4A, 4B, 4C, and 4D show examples of applying a further discrete-time modulation to an optical signal after generation by the electromagnetic radiation source of FIG. 1.

FIG. 5 shows alternative designs for an optical mixer and receiver which provide polarization-diverse detection.

FIGS. 6A and 6B show optical signals prior to photodetection in a balanced receiver configuration such as on the upper (FIG. 6A) and lower (FIG. 6B) optical outputs of the balanced detector of FIG. 1, prior to detection by the balanced detector.

FIGS. 7A and 7B show crosstalk between adjacent pulses that is generated by using conventional receiver designs within a discrete-time coherent ranging system.

FIGS. 8A and 8B illustrate output of a discrete-time coherent ranging system.

FIGS. 9A and 9B illustrate input 900a (FIG. 9A) and output 902a (FIG. 9B) pulses in a coherent ranging system with a discrete-time receiver employing Nyquist pulses.

FIGS. 10A and 10B illustrate an embodiment in which the crosstalk on the initial digital samplings can be removed through deconvolution.

FIGS. 11A, 11B, and 11C illustrate a system diagram (FIG. 11A) and sample input (FIG. 11B) and output (FIG. 11C) timing diagrams for a system which includes a photodetector having an integrate, hold, and dump functionality.

FIG. 12 illustrates a discrete-time coherent ranging system which includes a timing clock to synchronize/coordinate operation of one or more elements of the discrete-time coherent ranging system.

FIGS. 13A and 13B illustrate a discrete-time coherent ranging system (FIG. 13A) in which the receiver deinterleaves output data pulses to at least two different optical output paths (FIG. 13B).

FIGS. 14A and 14B illustrate a procedure for reducing or eliminating unwanted signal arising from reflections off of components such as a lens.

FIG. 15 illustrates an implementation of a discrete-time coherent ranging system which includes 32 separate optical channels and which is coupled to a laparoscope.

FIG. 16A illustrates a source for use with a discrete-time coherent ranging system which is an implementation of a phase-code mode locked (PCML) laser and FIG. 16B shows exemplary discrete output pulses generated by the source at wavelengths λ₁, λ₂, . . . λ₇₂.

FIG. 17 illustrates an implementation of a passive polarization modulator.

FIG. 18 illustrates phase modulation using an implementation of an active (e.g., controlled via a voltage-driven electro-optic modulator) phase and polarization modulator, which can be inserted into the setup in FIG. 15.

FIG. 19 illustrates polarization modulation using an implementation of an active (via a voltage-driven electro-optic modulator) phase and polarization modulator, which can be inserted into the setup in FIG. 15.

FIG. 20 illustrates a Sagnac interferometer based implementation of a polarization modulator in which a series of pulses (upper left) is produced after being transmitted through a phase modulator PM1 which is then polarized to produce the pulses shown in the lower right which have different wavelengths λ₁ and λ₂, different polarities Rx and Ry, and different phases I and Q.

FIG. 21 illustrates phase and polarization encoded pulses at the end of the sample arm (top) and reference arm (bottom), where the sample arm encoding is achieved via the modulator shown in FIGS. 18-20 and the reference arm encoding is achieved via the passive polarization modulator in FIG. 17.

FIG. 22 shows a photograph of imaging of a fingertip/fingernail region using a discrete-time coherent ranging system according to the disclosure (left) and a structural OCT micrograph produced by the imaging (right).

FIG. 23 shows images of a phantom made by imaging pieces of tape (top) showing the pieces of tape using structural (left) and polarization-sensitive (right) OCT.

FIG. 24 illustrates the phase encoding scheme for the phase and polarization modulators described in FIGS. 18-21.

### DETAILED DESCRIPTION

In accordance with some embodiments of the disclosed subject matter, mechanisms (which can include systems, methods, and apparatus) for discrete-time coherent ranging are provided.

Coherent ranging based on discrete-time, wavelength-stepped optical sources offers many advantages. For example, these sources, when implemented in a circular-ranging configuration, can achieve higher speeds and longer depth ranges for a given electronic acquisition bandwidth. In these systems, the discrete stepping of wavelength implies that the light signals incident on the receiver are discrete-time formatted. However, discrete-time coherent ranging systems demonstrated to date have relied upon receivers built and optimized for continuous-time signals, where this lack of a suitably designed receiver can contribute to performance and cost penalties. Thus, novel designs for receivers and/or sources are needed to fully leverage the technological and performance advantages of discrete-time coherent ranging methods. As used herein, coherent ranging refers to interferometry methods including optical coherence tomography (OCT). It also includes methods such as optical frequency domain ranging, optical frequency domain reflectometry (OFDR), and any other frequency-modulated laser-based light detection and ranging method, and LIDAR when based upon the interference of coherence light.

In conventional coherent ranging systems based on a wavelength-swept light source, the output optical signal of the system is in the form of an analog/continuous-time signal, where the depth locations within the sample are encoded by the modulation frequency content of the output signal. As a result, the receiver used in these types of systems, which is responsible for photodetection and digitization of the output signal, is designed to function as an RF spectrum analyzer. As such, the receiver follows several well-known principles. Given that signal detection is based on frequency content of the signals, the sampling clock is chosen such that the measured RF frequency content in the signal lies below the Nyquist frequency (which is equal to half the sampling clock frequency). This most commonly involves the placement of an electronic anti-aliasing or low-pass filter within the detection/measurement system to attenuate signals above the Nyquist frequency. Even recent OCT methods that use pulsed optical sources such as circular ranging (Lippok et al., Opt. Lett. 47, 1903-1906 (2022), incorporated herein by reference for all purposes) follow this same principle, i.e., treat the signal as being encoded within the RF spectrum over a given bandwidth and as a result employ a receiver designed to capture this bandwidth accurately and without electronic aliasing.

In the present disclosure, coherent ranging systems based on pulsed light sources and employing discrete-time receivers are disclosed. In these systems, and unlike conventional systems referenced above, the output optical signal is a discrete-time sequence of independent and temporally isolated pulses derived from a sequence of independent and temporally isolated pulses returning from the sample to the receiver. The receiver, therefore, serves to create a sequence of digital measurements where each digital measurement is a value based on the optical energy of the respective pulse returning from the sample and where the measured energy is associated with one and only one of these returned sample pulses (i.e., the digital measurement for a given pulse returned from the sample is not substantially contaminated with energy of temporally adjacent pulses returned from the sample). In doing this, the receiver is not configured to perform an RF spectrum analysis, and it is, in fact, designed to avoid such a goal. This is because the receiver in this disclosed system is configured such that the RF spectral content of the signal delivered to the analog-to-digital converter extends beyond the Nyquist frequency associated with the output rate of the digital sequence (i.e., half the digital sequence output rate). As a consequence, embodiments of the presently-disclosed systems are configured to create electronic aliasing in a particular manner. This is done to allow each temporally isolated pulse to be measured accurately and independently of neighboring pulses.

In various embodiments, the present disclosure provides receivers for discrete-time coherent ranging systems. In addition, the present disclosure provides apparatus and methods for modulating optical signals in phase and polarization that can be combined with discrete-time receivers, including the receivers disclosed herein. Further, the present disclosure provides apparatus, methods, and systems for reducing unwanted back-reflection signals that can be combined with discrete-time receivers, including in the systems disclosed herein.

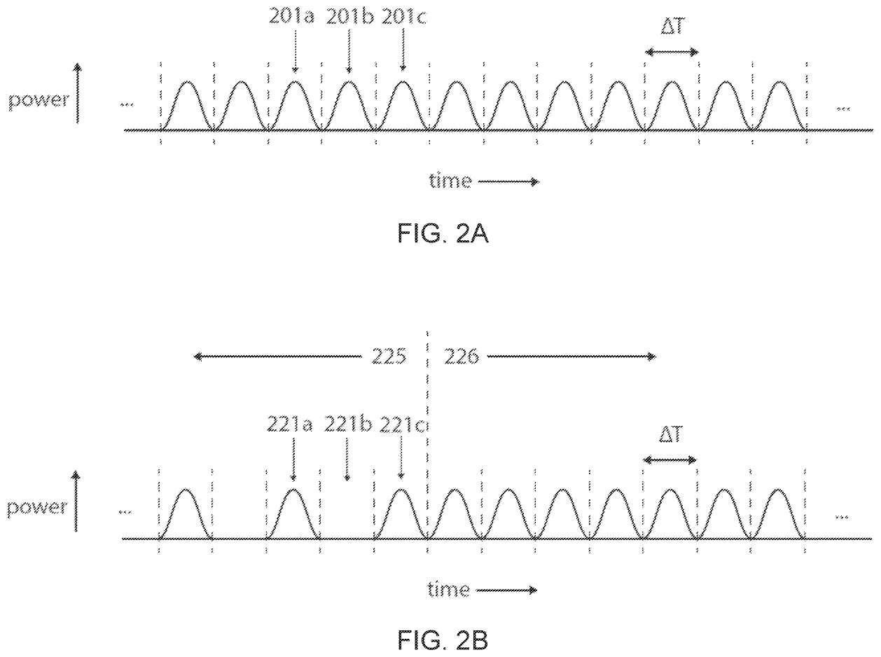

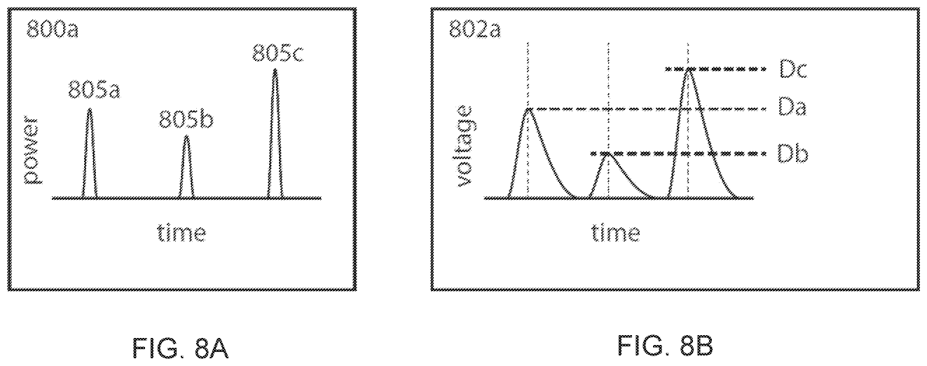

In various embodiments disclosed herein, an optical discrete-time signal is one in which an optical property of that signal, including but not limited to wavelength, phase, or polarization, changes discontinuously with time. In general, discrete-time sources produce output in the form of a series of distinct pulses that can be temporally distinguished from one another. Further, the discrete-time pulses may be emitted at regular intervals and the pulse string may include pulses at every time interval (FIG. 2A) and/or may include some time intervals without pulses (FIG. 2B). In addition, the discrete-time pulses may extend for the entire time interval (e.g., FIG. 2A, “100% duty cycle”) or alternatively may extend for only part of each time interval (FIG. 8, left panel), where the duty cycle is less than 100%. In various embodiments, the duty cycle of the pulses can be about 10%, about 20%, about 25%, about 30%, about 40%, about 50%, about 75%, about 90%, or any other suitable percentage.

One example of an optical discrete-time signal is a wavelength-stepped optical frequency comb source in which the output steps discontinuously across the spectral lines of a frequency comb. This contrasts with a wavelength-swept light source that generates an output wavelength that changes continuously over time, as indicated by the term “swept,” which is distinct from the “stepped” output of a comb source or similar source. For example, Circular Ranging (CR) optical coherence tomography can use a light source that steps discretely in wavelength among the spectral lines of an optical frequency comb and skips over the wavelengths that are interior to (between) those spectral lines.

In certain embodiments, the embodiments of receiver designs disclosed herein may be applicable to a wide range of discrete-time encoding, i.e., the pattern of wavelength, phase, polarization, or another optical parameter is modulated according to a discrete-time format. Specific encodings are therefore exemplary of a specific coherent ranging methodology used to illustrate the receiver and are not limiting.

In particular embodiments, the disclosed receivers and related procedures may be used to transform a discrete-time coherent ranging optical signal to a signal such as a digital signal (as discussed further below, the term digital signal as used herein may refer to a value that is based on an optical energy of a measured output signal). As such, these receivers can be used within a variety of coherent ranging system architectures that can include, for example, an electromagnetic radiation source, an interferometer, an optical mixer configuration, a receiver, and/or a modulator. The various system designs disclosed herein are exemplary of how these receivers can be used and are not limiting in scope.

In the present disclosure and embodiments presented herein, it should be noted that discrete-time and continuous-time signals refer to the encoding format applied to an optical or electrical signal, consistent with how those terms are used within communications fields. For optical signals, this encoding can be in terms of at least one of the amplitude, phase, wavelength, polarization, or another optical parameter. For electronic signals, this can be in terms of at least one of voltage, current, or other suitable electrical parameters.

Nevertheless, while the presently-disclosed procedures may resemble work in other fields such as in the telecom space, there are a number of distinctions that make the present work unique. For example, the present procedures require methods for reducing crosstalk to a much lower level than is required in telecom systems. In addition, the transmission channel in telecom systems (which may be many meters or kilometers in length) induces an unknown distortion to the pulse whereas in the presently-disclosed systems the transmission channel is relatively short (e.g., a meter or less) and its environment can be controlled/shielded, so it can be assumed that the pulse arriving at the receiver has the same shape as the pulse that was emitted from the source.

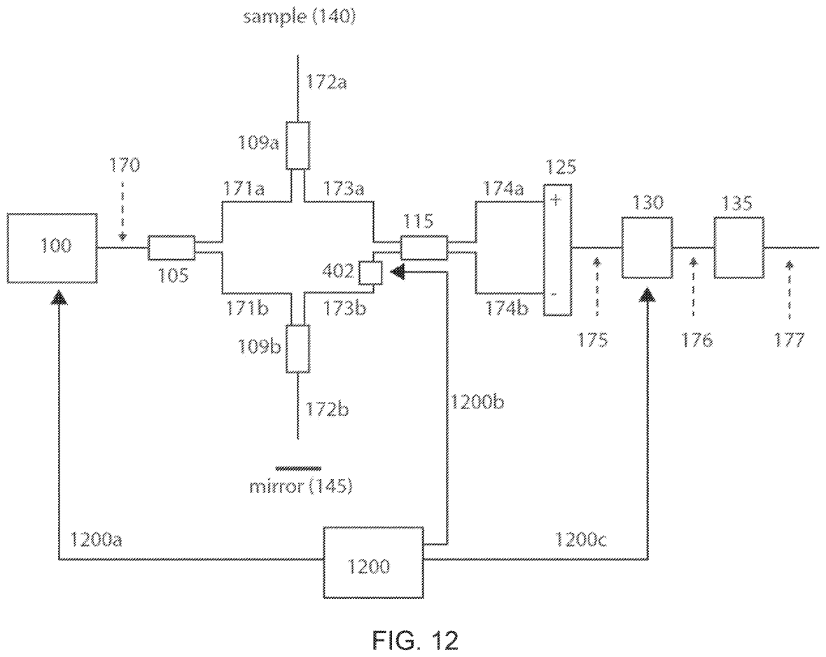

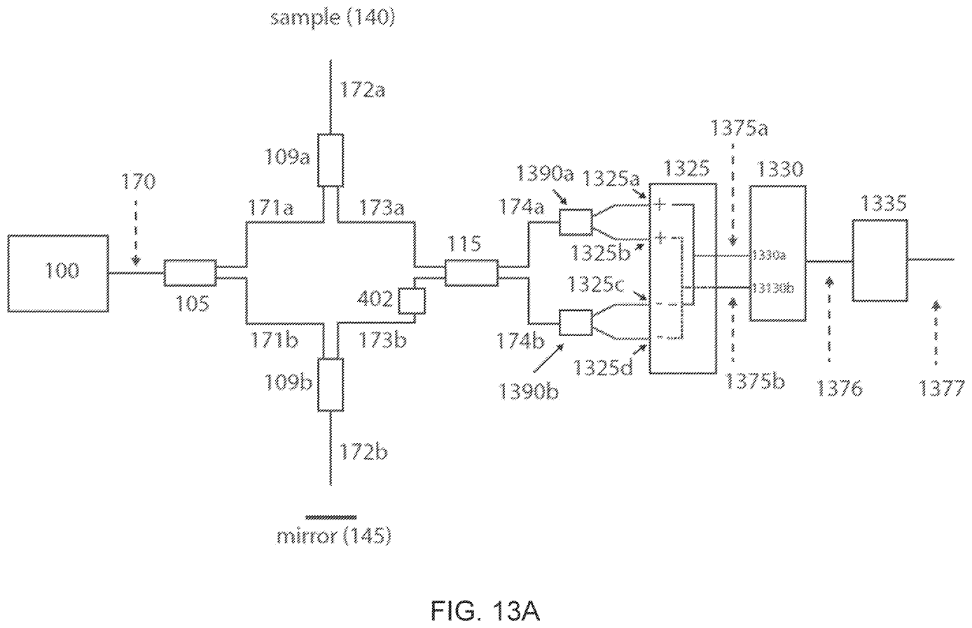

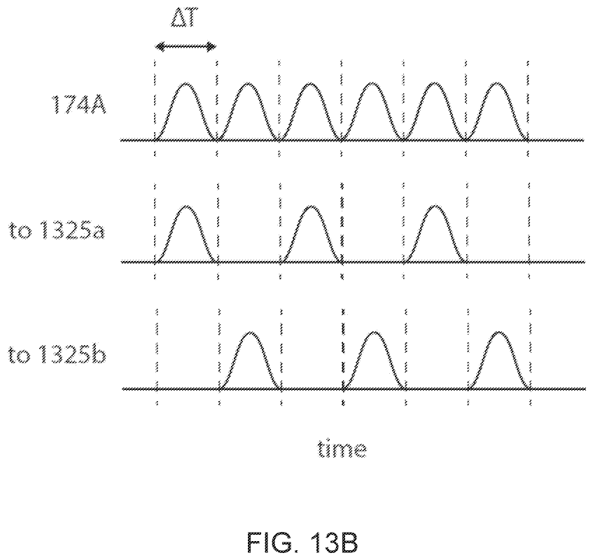

Furthermore, in telecom systems the “clock” (i.e., the frequency and phase of pulse arrival) must be derived from the pulse sequence using a clock recovery circuit. On the other hand, in the presently-disclosed systems it is possible to directly/physically synchronize the receiver clock to the source clock using electrical connections (e.g., see element 1200 in FIG. 12). In addition, the disclosed procedures allow one to use the wavelength properties of the pulse to aid in the reduction of intersymbol interference (ISI), such as in FIG. 13, whereas in telecom a given channel is assumed to have a consistent wavelength and thus it is not possible to distinguish pulses based on wavelength.

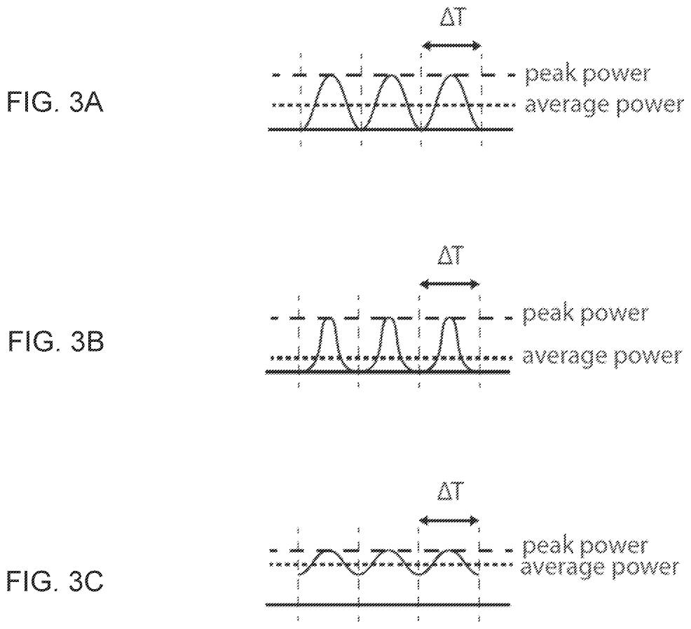

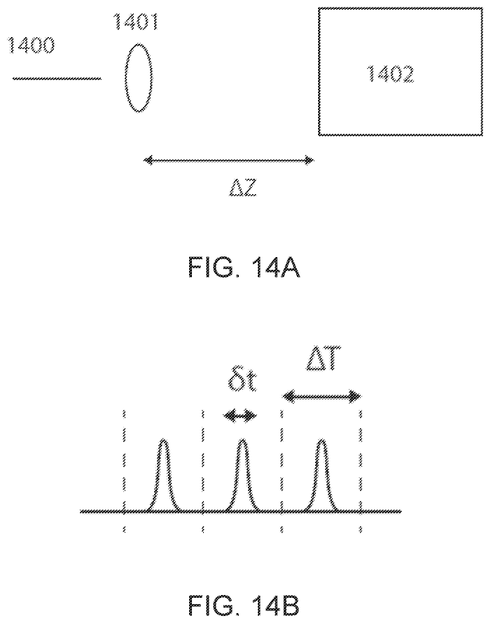

Finally, while telecom systems require spectral efficiency to be maximized in order to make optimal use of the available channels, the presently-disclosed devices do not have this constraint. Thus, in the presently-disclosed systems pulses can be implemented which are shorter (sometimes substantially shorter) than the pulse spacing (e.g., see FIG. 3B). In telecom systems, using pulses that are shorter than the spacing ΔT causes the spectral linewidth of the channel to be bigger than is nominally required, which limits the density at which spectral channels can be packed into the communication line. This is not an issue in the present systems and in fact short pulses can even be advantageous insofar as they can be used to remove unwanted reflections (FIG. 14).

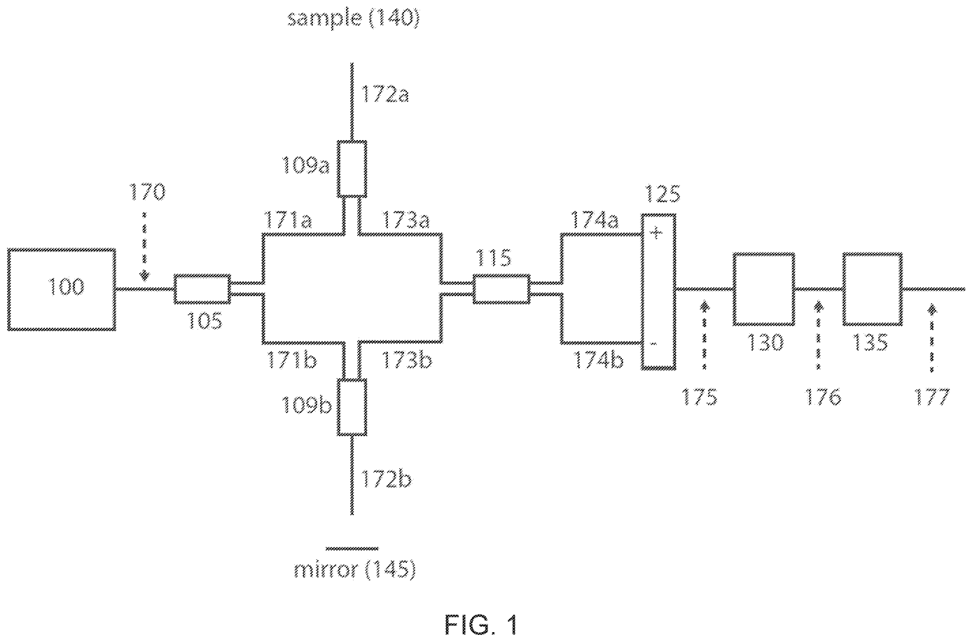

Accordingly, FIG. 1 shows an embodiment of an exemplary discrete-time coherent ranging system. An electromagnetic radiation source 100 generates a discrete-time optical signal 170 that is directed to an optical beam splitter 105. The beam splitter 105 divides the optical signal 170 into a sample arm optical signal 171a and a reference arm optical signal 171b. In the sample arm, a further beam splitter 109a is used to direct sample arm light to light path 172a and from there to sample 140. Reflections or optical scattering from sample 140 are collected by the path 172a, which can be an optical fiber or optical waveguide or free-space path. A portion of this reflected light is directed along the optical path 173a toward a mixing optical coupler, or mixer 115. The reference light is manipulated similarly toward optical path 173b but with a reflector or mirror 145 in place of the sample 140. The mixer 115 is an optical coupler with nominal coupling of 50% which combines the optical fields 173a and 173b to generate an interference signal on each of its outputs 174a and 174b. These interference signals 174a, 174b are the optical output of the coherent ranging system and are directed to photodetectors within a balanced detector 125 which includes two inputs that receive the signals 174a, 174b and which converts the optical energy to an electrical signal at each photodetector (labeled “+” and “−”) and subtracts those electrical signals from each other to remove optical intensity noise.

The balanced detector 125 generates an electrical output signal 175, which is transmitted to an analog-to-digital converter (ADC) 130. The ADC 130 creates a digital signal 176, which is transmitted to a processing system 135. The processing system 135 uses one of any known methods for analyzing digital signals to obtain positional information on the sample and provides an output 177. This can include, for example, Fourier transformation, and in general, the processing system 135 algorithm is configured according to the optical encoding of the discrete-time optical signal 170.

The electromagnetic radiation source 100 can be, for example, a frequency comb stretched pulse mode-locked (SPML) laser, a frequency comb phase code mode-locked (PCML) laser, or an integrated photonic frequency comb laser. Any source technology providing discrete-time optical signals, as defined above, can be used as an electromagnetic radiation source.

The system in FIG. 1 shows optical paths that can be implemented using free-space optics or which alternatively may be based on waveguides such as optical fibers or integrated photonic waveguides.

FIGS. 2A and 2B show exemplary discrete-time optical signals, such as the signals 170 that would be generated by the electromagnetic radiation source 100 in FIG. 1. In FIG. 2A, the discrete-time optical signal features a sequence of non-overlapping optical pulses. Three successive pulses, 201a, 201b, and 201c, are labeled. The temporal spacing between the pulses is ΔT and is consistent for all pulses. FIG. 2B shows a discrete-time optical signal featuring null pulses, i.e., a time slot 221b that does not contain a pulse, while adjacent time slots 221a and 221c contain pulses. In FIG. 2B, the discrete-time source can provide an agile signal such that for some periods of time 226, each time slot separated by ΔT contains a pulse, while for other periods of time 225, some time slots may not contain a pulse. As such, the discrete-time source can provide pulses with separations of NΔT where N is a positive integer that can change over the course of operation of the source.

FIGS. 3A, 3B, and 3C show various embodiments of pulse shapes for the discrete-time optical signal 170 generated by the electromagnetic radiation source 100. In each of FIGS. 3A and 3B, the pulse amplitude falls to zero at the boundary between the pulses. In FIG. 3A, the peak pulse power is twice the average power of the pulse over the time slot of duration ΔT containing that pulse. In FIG. 3B, the peak pulse power is four times the average power of the pulse over the time slot of duration ΔT containing that pulse. In FIG. 3C, pulses with amplitudes that do not fall to zero at their edges are illustrated. In general, discrete-time optical pulse amplitudes can be either return-to-zero (RZ) formatted (FIGS. 3A, 3B) or non-return-to-zero (NRZ) formatted (FIG. 3C), and for RZ formatting the ratio of peak power to average power over the timeslot can be configured by the design of the electromagnetic radiation source to be anything above 1.0, including for example a value between 2 and 10, or any values greater than 1.0. This pulse amplitude shaping can be used in combination with specific receiver configurations described later to optimize signal capture performance. The electromagnetic radiation source can be configured to provide a specific pulse shape intrinsically, or an amplitude modulator can be added within the electromagnetic radiation source to further impose a shaping function on the pulses. The amplitude modulator can be implemented using any of a number of technologies known to those skilled in the art, such as a lithium niobate or other electro-optic intensity modulator or a current-modulated semiconductor optical amplifier.

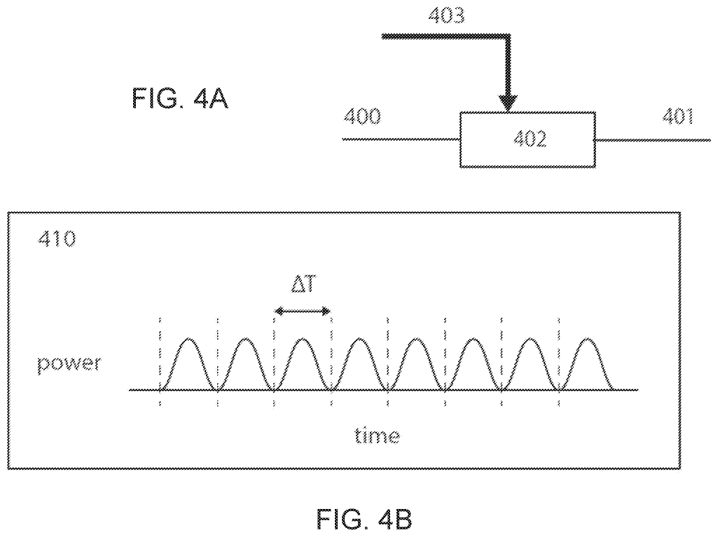

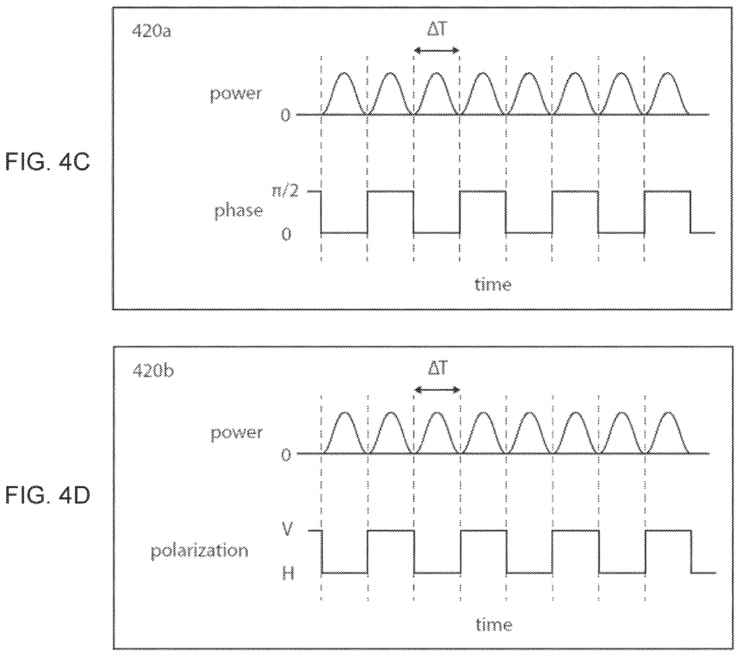

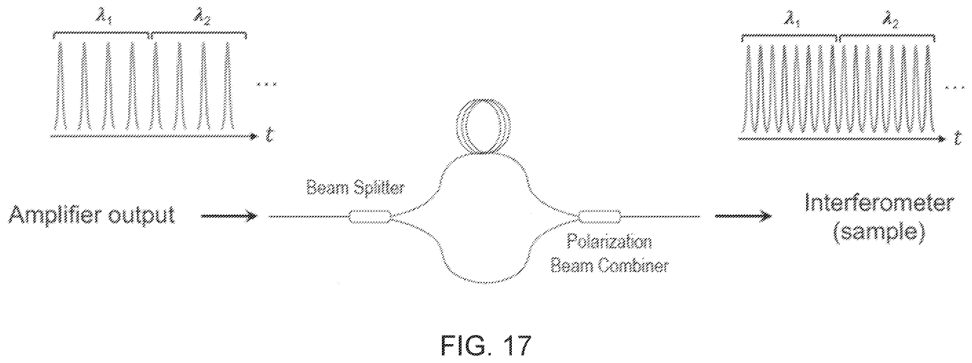

In some embodiments, it is useful to apply a further discrete-time modulation to the optical signal after generation by the source 100. This can be done by passing incoming discrete-time optical signal 400 (FIGS. 4A, 4B) through an optical modulator 402 to generate an output discrete-time signal 401 with additional modulation. The modulator 402 can be driven by an electrical signal 403, which creates a discrete-time encoding synchronous to the arrival of the discrete-time optical pulses to the modulator. FIG. 4C (Panel 420a) shows the output discrete-time optical signal power and phase when the modulator 402 is a phase modulator configured to modulate phase by 90° between adjacent pulses. A phase modulator can be an electro-optic phase modulator, such as a lithium niobate phase modulator. FIG. 4D (Panel 420b) shows the output discrete-time optical signal power and polarization when the modulator 402 is a polarization modulator configured to modulate polarization between Horizontal (H) and Vertical (V) states. A polarization modulator can be an electro-optic polarization modulator such as a lithium niobate phase modulator. The modulator 402 can be located prior to the interferometer (e.g., before beamsplitter 105, inside the sample arm at, for example, 171a or 173a, or inside the reference arm at 171b or 173b). Multiple modulators can be incorporated into the system to apply complex discrete-time modulations to the radiation 170 or a radiation field derived from the radiation 170. Further embodiments of optical modulators are shown in FIGS. 17-20 and described below.

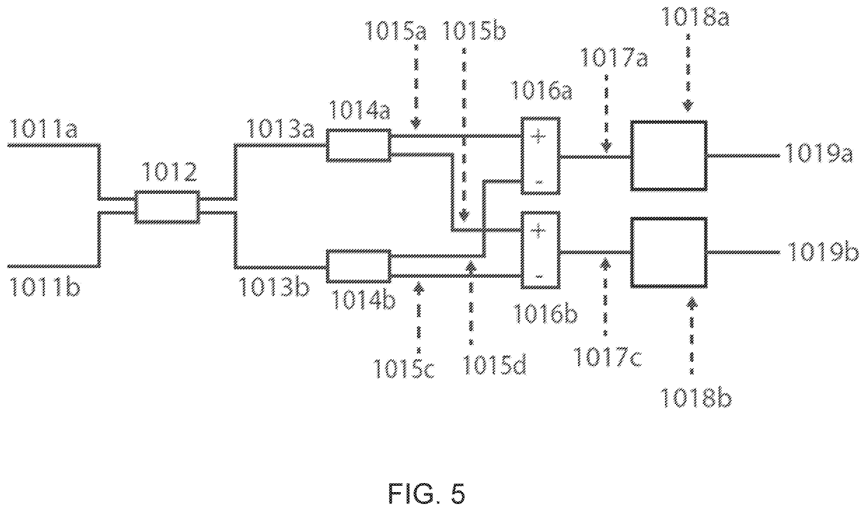

FIG. 5 shows alternative designs for the optical mixer and receiver providing polarization-diverse detection. Here light field 1011a corresponds to the light field 174a and 1011b to 174b. Optical device 1012 is an optical coupler with nominal coupling of 50%. Output interference signals 1013a and 1013b couple to polarization beam splitters 1014a and 1014b to generate optical signals in a horizontal polarization 1015a and 1015d, and optical signals in the vertical polarization 1015b and 1015c. These signals are connected to balanced receivers 1016a and 1016b to generate electrical signals 1017a and 1017c describing the sample response in the horizontal and vertical polarization, respectively. These signals couple to digitizers 1018a and 1018b to generate digital signals 1019a and 1019b. FIG. 5, therefore, illustrates a further optical mixer configuration that can be included within the discrete-time receiver designs presented hereafter. Additional coherent ranging mixer designs such as phase-diverse (in-phase and quadrature detection) can also be used.

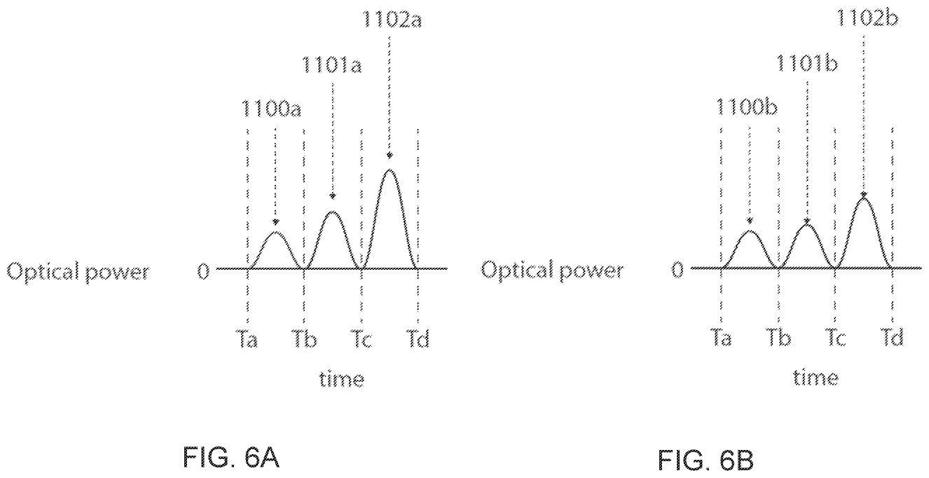

FIGS. 6A and 6B show the optical signals prior to photodetection in a balanced receiver configuration, such as, for example, on optical output 174a (FIG. 6A) and 174b (FIG. 6B), prior to detection by balanced detector 125. In the present disclosure, apparatus, methods, and systems are provided for generating a digital signal 176 including a sequence of digital numbers 1010,1011,1012 where digital number 1010 is proportional to the optical energy of pulse 1100a integrated from Ta to Tb (e.g., integrated during a duration of the pulse) minus the optical energy of pulse 1100b integrated from Ta to Tb. Similarly, digital number 1011 is proportional to the optical energy of pulse 1101a integrated from Tb to Tc minus the optical energy of pulse 1101b integrated from Tb to Tc. Importantly, procedures are provided such that the digital number 1011 is maximally correlated to the difference of the optical energies of pulses 1101a and 1101b as described above, while also being minimally affected by the optical energies of the preceding and following pulses 1100a, 1100b, 1102a, 1102b, as discussed further below. Thus, the present disclosure identifies receiver designs specifically configured for discrete-time signals such that the information of each pulse can be measured (as a digital number) without crosstalk from neighboring pulses. The terms digital numbers or digital values as used herein refer to signals that are measured and quantified by detectors in discrete-time systems which are based on the optical energy of the detected pulse, in contrast to detectors used for known coherent ranging systems which generate spectral measurements that are based on the RF spectrum of the pulses.

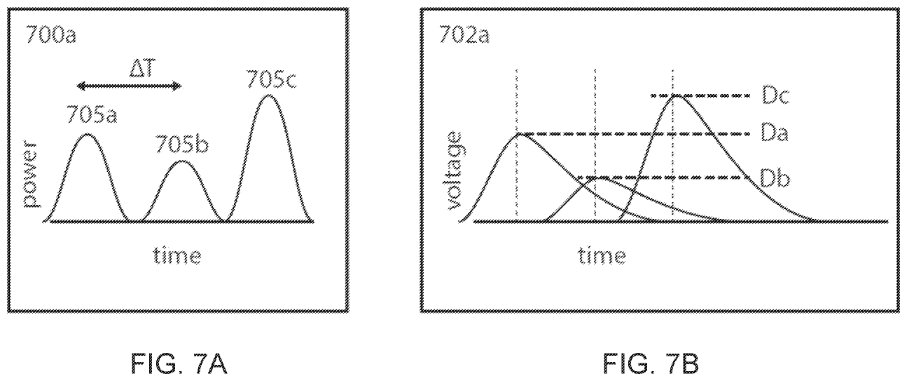

FIGS. 7A and 7B show the crosstalk between adjacent pulses that is generated by using conventional receiver designs within a discrete-time coherent ranging system. A set of RZ optical pulses 700a (FIG. 7A) are incident on a photodetector such as 125. Each of the shown three pulses (taken out of a longer sequence of pulses which have been omitted for clarity and convenience) are 705a, 705b, and 705c. These pulses are non-overlapping and spaced by ΔT. In conventional methods, the information contained by this pulse train is completely captured in the RF frequency range from DC to 1/(2ΔT) from the Nyquist theorem. As such, a conventional receive design would digitize the signal at twice this frequency, i.e., at a sampling rate of 1/ΔT, and use an analog low-pass filter with a corner frequency near the Nyquist frequency of 1/(2ΔT). However, the filtering of these pulses by such a low-pass filter will generate significant extensions in the time domain 702a (FIG. 7B), leading to substantial pulse overlap and high crosstalk. For example, the Measurement Db is affected significantly by the tail of the response to pulse 705a. Thus, the need to independently measure each pulse in discrete-time coherent ranging requires that different receiver designs be employed. In the following, various embodiments of such receiver designs are provided.

FIGS. 8A and 8B illustrate output of a discrete-time coherent ranging system configured with an analog bandwidth substantially greater than the Nyquist value of 1/(2ΔT) in concert with an electromagnetic radiation source providing RZ pulses 800a (FIG. 8A) with widths substantially less than the pulse spacing, or equivalently with a peak power that is at least 2× the average power of the pulse. The resulting electrical output 802a (FIG. 8B) of the detector (such as balanced detector 125 in FIG. 1) shows that pulse temporal broadening is confined to a shorter duration such that, for example, the digital sampling Db (time of sampling of the output pulse corresponding to input pulse 805b) is not affected by the response to pulse 805a or pulse 805c. Thus, a receiver design with analog bandwidths greater than 1/(2ΔT) combined with RZ optical pulses shorter than the pulse separation can be used to eliminate or mitigate crosstalk in a discrete-time coherent ranging system. In one embodiment, a system with a pulse separation of ΔT=10 ns and a pulsewidth of 4 ns using an analog bandwidth of 100 MHz (twice 1/(2ΔT)) can be used to reduce crosstalk. In another embodiment, a receiver low-pass filter with a corner frequency in the range of 1.2/(2ΔT) to 1.5/(2ΔT) can be used to reduce crosstalk (known as intersymbol interference (ISI)) without compromising signal-to-noise-ratio (SNR). For pulses that are much shorter than the pulse repetition time, the receiver bandwidth can be relaxed (increase) to find optimum low-pass filter that cancels pulse overlap (ISI) without compromising SNR. The exact discrete-time receiver bandwidth is system specific (pulse shape, pulse repetition rate, low-pass filter type) and must be determined on an individual system basis. Note that conventional approaches in coherent ranging utilize sources with an approximately constant power, and that the inclusion of sources with such extensive times with no optical power is generally viewed as suboptimal due to the loss of light that would be located at these times, or due to the need to support higher peak powers in order to maintain a given average power.

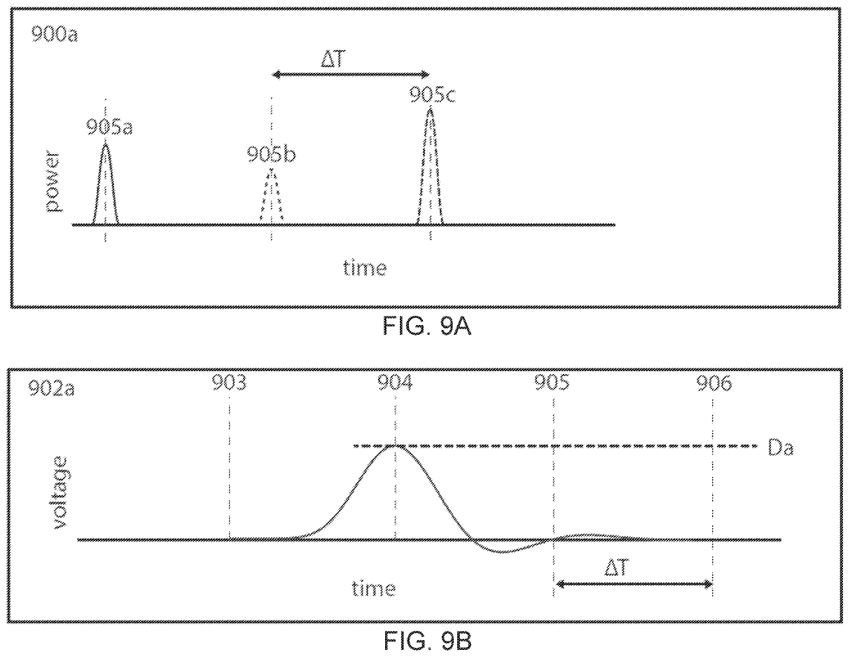

FIGS. 9A and 9B illustrate input 900a (FIG. 9A) and output 902a (FIG. 9B) pulses in a coherent ranging system with a discrete-time receiver employing Nyquist pulses. (Note that “Nyquist pulses” are shaped pulses which is distinct from the reference to the Nyquist frequency provided above.) In FIG. 8, an embodiment for limiting crosstalk based on confining the temporal response of the photodetector system to be less than the pulse spacing was shown. FIGS. 9A and 9B illustrate an alternative approach wherein the photodetector is allowed to broaden the pulse beyond the spacing between pulses but the photodetector filter response and input optical pulse shape are configured such that the resulting response has nulls at preceding and following sampling times. As a result, each of the output values determined by the detector is based on the optical energy of the respective pulse with minimal contribution from adjacent pulses. A sequence of optical pulses shown in 900a (FIG. 9A) is incident on the photodetector, such as balanced detector 125 in FIG. 1. Three pulses out of a longer sequence are shown as 905a, 905b, and 905c, where the pulse spacing is ΔT. The photodetector is configured with an analog bandwidth and filter response such that the resulting electronic response from pulse 905a is shown in 902a (FIG. 9B). Note that the temporal response extends beyond ΔT, but if sampling is performed at times 903, 904, 905, and 906, then the pulse provides a maximum response at sampling time 904, and the response at 905 is zero. Likewise, the response at 903 and 906 is zero. That is, the pulses emitted from the source are configured to be sufficiently short so that the output pulses striking the detector are brief relative to the response time of the detector, so that the response of the detector to a given pulse accurately measures the pulse but that pulse's signal does not impact the readings of the adjacent pulses. This allows lower analog bandwidths to be used to better suppress noise without inducing crosstalk, as was generated in the example of FIG. 8.

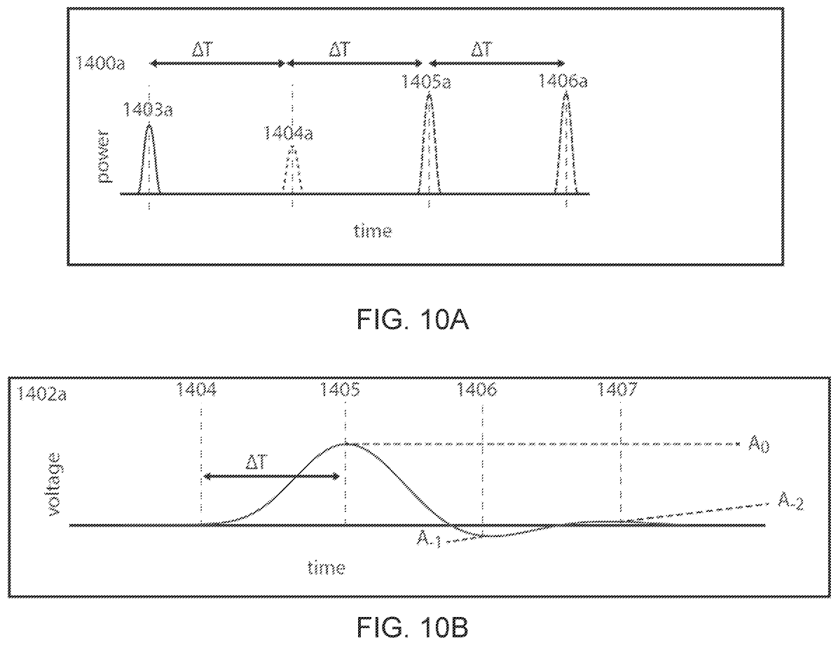

FIGS. 10A and 10B illustrate an embodiment in which the crosstalk on the initial digital samplings can be removed through a deconvolutional algorithm implemented on the processing system after digitization, for example, on processing system 135 in FIG. 1. These calculations as based in part on a characterization of the response pattern of the detector to an incoming pulse, so that one can use deconvolution to effectively undo the impact of the system response on adjacent pulses. A sequence of optical pulses 1403a, 1404a, 1405a, and 1406a is incident on a photodetector 125 (panel 1400a, FIG. 10A) and, due to the analog bandwidth/system response of that detection system, induces significant pulse broadening on the electrical output due to each pulse, where the electrical output for the single pulse 1405a is illustrated in 1402a (FIG. 10B). Also shown in 1402a are specific sampling times 1404, 1405, 1406, 1407 spaced by ΔT where 1404 is prior to 1405. The electrical signal amplitude at these points can be written as A₊₁ for sampling 1404, A₀ for 1405, A₋₁ for 1406 A₋₂ for 1407. The digital value measured by the sampling at time 1405, which we denote as D₁₄₀₅, is therefore

$${D}_{1405} = {A}_{0} {P}_{1405} + {A}_{- 1} {P}_{1404} + {A}_{- 2} {P}_{1403}$$

where Pᵢ is the energy of pulse i. In more general terms, the digital measurement Dᵢ is given by

$${D}_{i} = {A}_{0} {P}_{i} + {A}_{- 1} {P}_{i - 1} + {A}_{i - 2} {P}_{i - 2}$$

where we have assumed Aⱼ is zero for j<−2 and j>0 for convenience, but it can be easily seen that the equation can be extended with more terms to cover scenarios wherein additional values of Aⱼ are nonzero. Note that Dᵢ is intended to measure only signal associated with pulse Pᵢ, but Dᵢ ends up including significant crosstalk from neighboring pulses due to non-zero values of A₋₁ and A₋₂, i.e., due to overlap of signal generated by adjacent pulses.

In this embodiment, a processing system acting on the digital samples Dᵢ can calculate a corrected set of digital samples Cᵢ where Cᵢ is proportional to Pᵢ and has minimized dependence or association with adjacent pulses, i.e., with the value of Pⱼ for j not equal to i. This can be done by calculating

$${C}_{i} = ( 1 / {A}_{0} ) {D}_{i} - ( {A}_{- 1} / {A}_{0} ) {C}_{i - 1} - ( {A}_{- 2} / {A}_{0} ) {C}_{i - 2}$$

where it is assumed that the values of Cᵢ₋₁ (=Pᵢ₋₁) and Cᵢ₋₂ (=Pᵢ₋₂) are known from a previous calculation. To initially perform this calculation at a particular index j, the values Cⱼ₋₁ and Cⱼ₋₂ can be assumed to be zero. The errors resulting from this assumption will diminish quickly due to the value of (A₋₁/A₀) and (A₋₂/A₀) being less than zero. In this embodiment, the corrected values Cᵢ can be calculated in real-time by, for example, a programmable logic computer such as a field-programmable gate array, an ASIC, a CPU, a GPU, or another suitable computational device capable of simple digital storage, arithmetic, and multiplication.

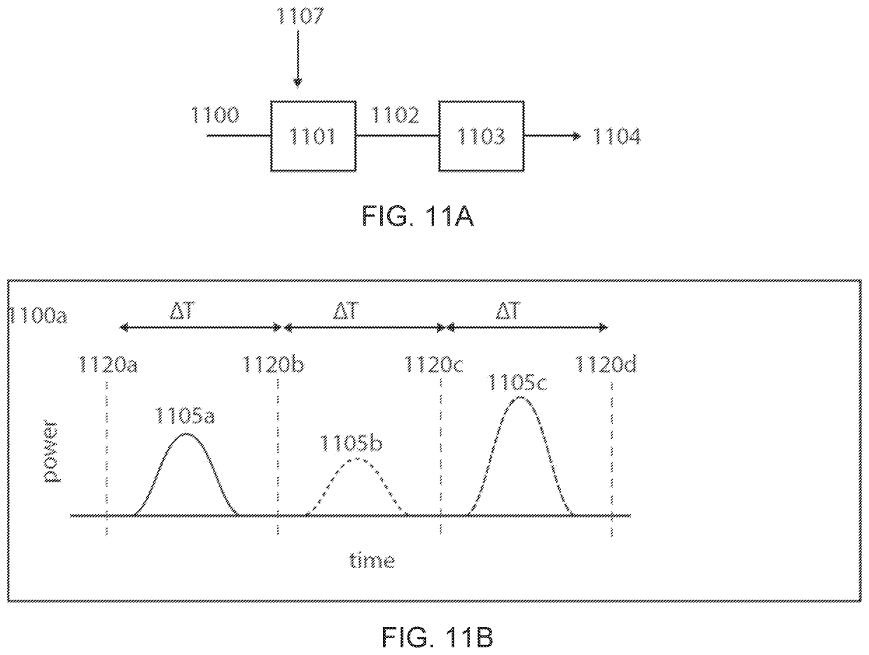

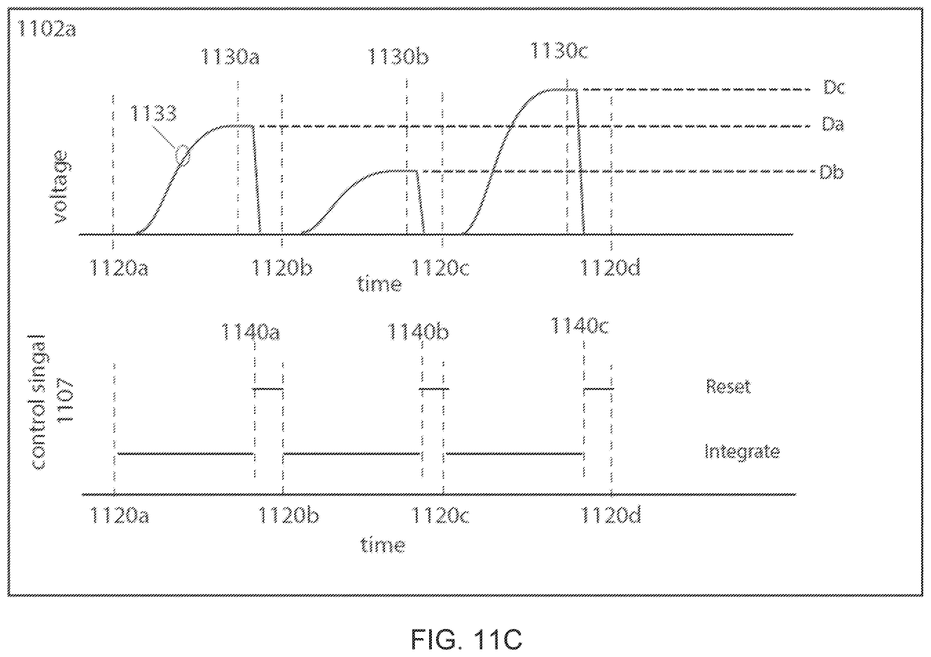

In one embodiment shown in FIGS. 11A-11C, the optical signal 1100 is incident on a photodetector 1101 which generates an electrical signal 1102 which in turn is connected to an ADC 1103, such that the ADC yields digital data 1104 (FIG. 11A). The photodetector 1101 is configured to provide an integrate, hold, and dump/reset functionality or an integrate and dump/reset functionality wherein the electrical output 1102 is an integration of the optical energy over a defined time period defined by control signals provided to the photodetector. In addition, the photodetector 1102 is configured to provide a dump functionality based on a control signal 1107 such that the integrated electrical signal can be reset to a baseline value such as, for example, ground. Thus, when the control signal sets the photodetector to an integrating state, the electrical signal integrates the optical current generated by the photoelectric conversion, and when the control signal sets the photodetector to a reset state, the electrical output is returned to and held at a baseline signal (e.g., ground). Alternatively, the control signal can place the photodetector in a third “hold” state in which the electrical signal is held at the current value during which an analog-to-digital sampling is performed. During this “hold” state, the electrical output does not respond to the optical input.

Panels 1100a (FIG. 11B) and 1102a (FIG. 11C) show an exemplary function of the embodiment. Three input optical pulses are shown in 1100a (FIG. 11B) with pulse time slots starting at 1120a for pulse 1105a, 1120b for pulse 1105b, and 1120c for pulse 1105c. The optical pulses are shown as RZ pulses but can optionally be NRZ formatted. In 1102a (FIG. 11C), the control signal logical states and the resulting electrical output are shown for an integrate and dump configuration. In this embodiment, the control signal 1107 is configured to place the photodetector into integrate mode at times 1120a, 1120b, 1120c and to place the photodetector into reset/dump mode at times 1140a, 1140b, 1140c. The resulting electrical signal 1133 rises during the optical pulse to a value that is proportional to the pulse energy. The ADC is configured through a control signal to sample the electrical signal 1133 at times 1130a, 1130b, and 1130c, which is prior to the reset signals 1140a, 1140b, and 1140c. As such, the digitized values Da, Db, and De associated with pulse 1105a, 1105b, and 1105c, respectively, are proportional to the energy of the associated pulse but made to have minimal response to the neighboring pulse energies. Yet the integrating functionality effectively removes the noise signals at higher frequencies, i.e., at RF frequencies greater than (½ΔT). In another embodiment, the control signal provides a hold function that precedes the dump/reset functionality, thus creating a time during which the signal is held steady and making it easier to align the ADC sampling time to the appropriate temporal location.

In one embodiment of the present disclosure, the timing properties of the electromagnetic radiation source and the ADC samplings are controlled via a common electronic clock apparatus such that the frequency and phase of the ADC clock are controlled to be in a specific alignment with the arrival time of the optical pulses at the receiver. In another embodiment, this common electronic clock extends to control also at least one of the frequencies and phases of the signals provided to optical modulators such as 402 and 502 or the control signal 1107. In this and other embodiments, it should be known that this synchronization is configured to account for optical and electronic delays between the electromagnetic radiation sources, the modulators, the photodetectors, and the ADC. FIG. 12 illustrates such an embodiment in which a common electronic apparatus 1200 provides signal 1200a configured to control at least the output timing of the pulses of the electromagnetic radiation source 100 and signal 1200c configured to control the timing of the analog to digital conversion of the ADC 130. Optionally, the electronic apparatus 1200 provides a signal 1200b configured to control at least the timing of an optical modulator 402 shown here within the signal path 173b but more generally can be located anywhere capable of providing an optical modulation to the light provided by the electromagnetic radiation source 100. It can be noted that existing coherent ranging systems can sometimes synchronize the digitization clock with a property of the source, but that there is no demonstration of a coherent ranging system that utilizes a frequency and phase clocking between the digitization clock and an optical pulse sequence generated by an electromagnetic radiation source. In prior demonstrations of coherent ranging using discrete-time electromagnetic radiation sources, the digitization clock was locked to a frequency relative to the electromagnetic pulse generation rate, but the phase of the digitization clock was not controlled (Siddiqui, M., Nam, A. S., Tozburun, S. et al. High-speed optical coherence tomography by circular interferometric ranging. Nature Photon 12, 111-116 (2018), incorporated herein by reference in its entirety). In one embodiment of the present invention, the digitization clock frequency and phase are locked to the optical pulse generation rate of the electromagnetic radiation pulse sequence, and the frequency of electromagnetic pulse generation at the source is equal to the frequency of the digitization rate at the digitizer.

In one embodiment, the receiver (FIG. 13A) is configured to deinterleave the optical pulse sequence to at least two separate optical output paths (FIG. 13B) wherein each optical path is directed to its own photodetector and ADC. In this embodiment, the spacing between pulses within the photodetector and ADC is increased and thereby reduces ISI. An input optical pulse sequence on 174a is incident on a deinterleaver apparatus 1390a with two outputs that direct light either toward photodetector 1325a or photodetector 1325b. Since this is a balanced configuration, a matching deinterleaver apparatus 1390b acts on the pulse sequence 174b and directs light to photodetectors 1325c and 1325d. The pulse sequence on 174a (and also on 174b) is shown in FIG. 13B as the top plot labelled 174a. The deinterleaved optical pulse sequence directed to photodetectors 1325a and 1325b are shown below. Note that the deinterleaved output is such that the temporal spacing between pulses is doubled in this configuration. It can be understood that while this example deinterleaves the pulse train to two outputs, a deinterleaver with three, four, or another integer number of output pulses can be used to further increase the spacing between pulses on the output. In FIG. 13, the same pulses selected for photodetector 1325a are selected for photodetector 1325c. Two balanced electrical signals 1375a and 1375b are generated and directed to two separate ADC channels 1330a and 1330b within the ADC apparatus 1330. The digital signal 1376 contains the samplings of the pulses from 1330a and 1330b, and these signals are directed to a processing system 1335. Here, the digital signals can be interleaved as required for further processing.

The deinterleaver apparatus 1390a and 1390b depicted in FIG. 13A can be a conventional optical frequency based optical deinterleaver that directs optical frequencies ν+2N (FSR) to one output and ν+(2N−1)(FSR) to the other port, where Nis an integer greater than 0. This optical frequency-based deinterleaver is common in telecommunications and can be based on free-space optical filters or integrated photonic filters including a Mach-Zehnder interferometer with a path-imbalance. In this configuration, the electromagnetic radiation source is configured to generate a pulse sequence such that adjacent pulses have an optical frequency such that neighboring pulses on 174a are separated on the deinterleaver output. For example, the electromagnetic radiation source can generate a sequence with optical frequencies:

$$[ ν o , ν o + 100 GHz , ν o + 200 GHz , ν o + 300 GHz ]$$

where the deinterleaver is configured with FSR=100 GHz so that one output contains νo and νo+200 GHz while the other output contains νo+100 GHz and νo+300 GHz.

The deinterleaver apparatus 1390a and 1390b of FIG. 13A can additionally be constructed using an active 1×N optical switch that uses a voltage signal, such as, for example, one generated by an electronic control apparatus 1200, to direct pulses to one of the N outputs such that the temporal spacing between the pulse on each output is increased relative to the spacing of the pulses on the input optical ports 174a and 174b. This 1×2 optical switch can be for example based on electro-optical modulation such as lithium niobate or thin-film lithium niobate integrated photonic platforms, or another 1×2 optical switch with switching speeds faster than ΔT.

In one embodiment, a discrete-time coherent ranging system uses RZ pulses with optical pulse widths δt that are configured to eliminate signals from specific structures within the sample arm optical path. In FIG. 14A, a sample arm optical beam from an optical fiber 1400 is incident on a focusing lens 1401 and directed toward a sample 1402. Light backscattered from the sample 1402 is coupled back to the fiber 1400 and directed to the coherent ranging receiver as described in FIG. 1, where 1400 is analogous to 172a. However, in some embodiments the lens 1401 may also reflect light back to the fiber 1400, which is an undesirable reflection signal. To address this, the electromagnetic radiation source 100 (see FIG. 1) may be configured to provide pulses having a pulsewidth δt, which is shorter than the time between pulses ΔT (FIG. 14B), such that the reflections from the lens 1401 are temporally separated/walked-off from the reflections of the sample 1402. When these reflected pulses (e.g., reflected from the lens or other component) return to the receiver, the system is configured to overlap the reference field pulses with the sample reflections only, which has the effect of not overlapping a reference field pulse with the lens reflection. This is made possible because the reflected pulses arrive at the receiver at a different time than the reference field pulses and the pulsewidth δt is sufficiently short relative to the time between pulses ΔT that one can essentially “mask off” the reflected signals by overlapping the signals scattered by the reference field and the sample with one another. As such, this configuration can reject interference from the lens but retain interference from the sample.

In this example, the temporal walk-off between the lens reflection and the sample reflection is given by 2*ΔZ/c, where c is the speed of light and ΔZ as shown in FIG. 14A is the distance between the lens and the sample. For example, if ΔZ is 2 cm, then δt should be less than 2*(0.02 m)/c=133 ps. If ΔZ is 10 cm, then δt should be less than 667 ps. The electromagnetic radiation source can optionally include a fast amplitude modulator such as a 1-50 GHz lithium niobate intensity modulator to create output pulses with the required pulsewidth.

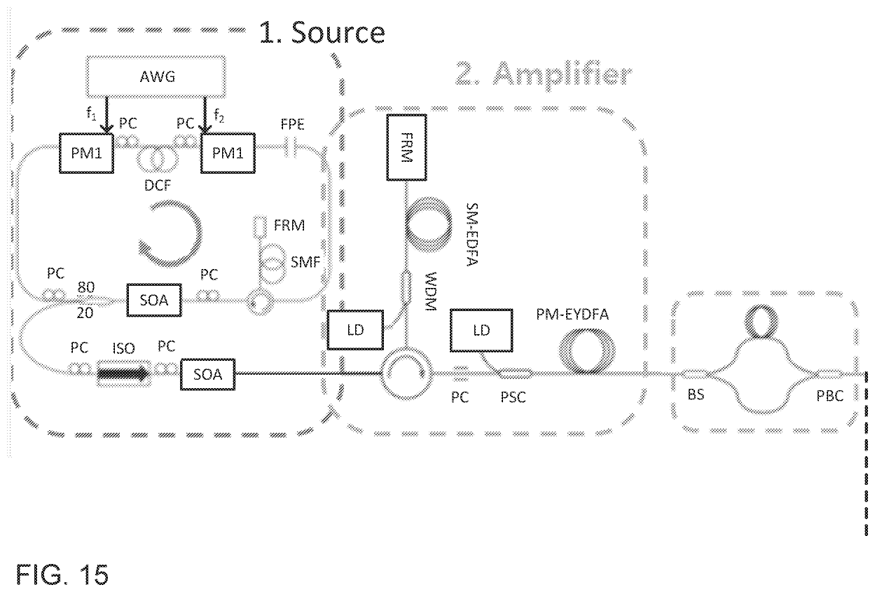

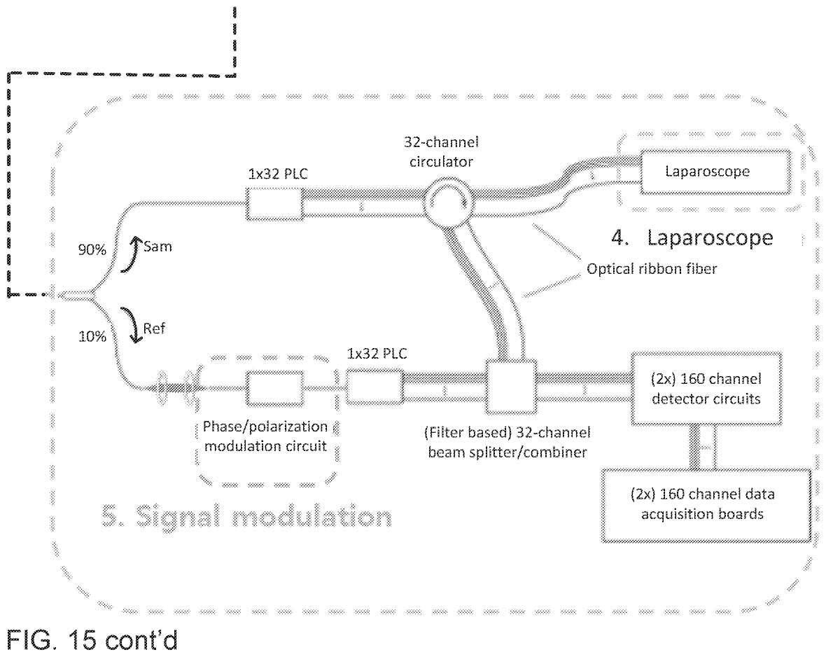

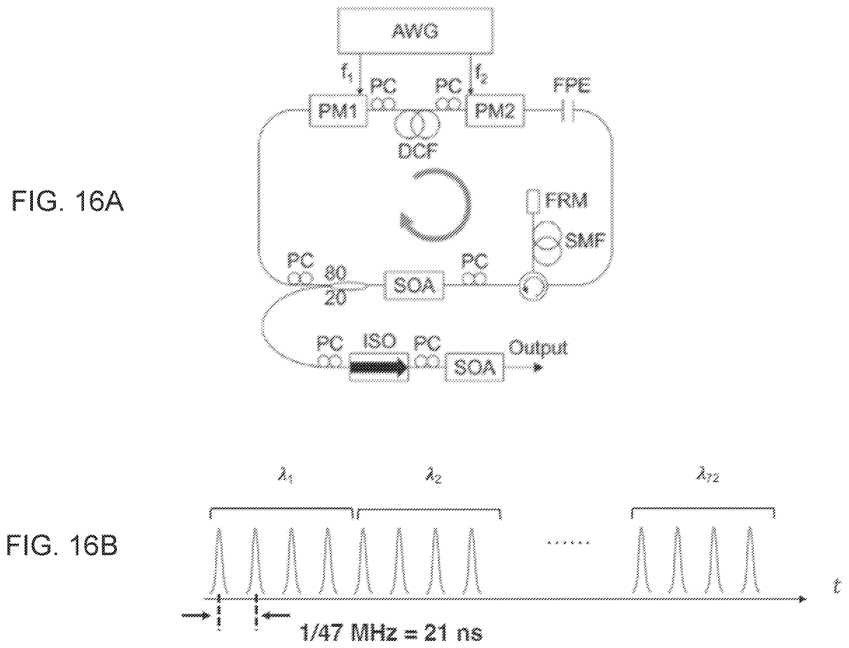

FIG. 15 shows a particular embodiment of a discrete-time coherent ranging system such as that presented in FIG. 1. The system of FIG. 15 is an implementation of a discrete-time coherent ranging system which includes 32 separate optical channels and is coupled to a laparoscope, with a goal of providing high-quality images at high speed/frame rate using a relatively small and thin sized probe; in various embodiments, the number of optical channels may vary from as few as 1 or 2 up to 100 channels or more. The system of FIG. 15 may include a phase-code mode locked (PCML) laser implementation of the programmable pulsed (discrete-time) electromagnetic radiation source (see FIG. 16A) which produces a series of discrete output pulses at wavelengths λ₁, λ₂, . . . λ₇₂ (FIG. 16B). The pulses of the source of FIG. 16 may have a duty cycle of less than 100%, which can help with reducing or eliminating overlap in output signals from adjacent pulses. In one particular embodiment, the central wavelength may be 1588 nm; the spectral bandwidth may be 48 nm; the free spectral range (FSR) may be 80 GHz; the A-line rate may be 164.4 kHz; and the output power may be 5 mW, with the pulses having a 50% duty cycle (FIG. 16B).

The system of FIG. 15 may also include an amplifier as well as a polarization modulator, such as the passive polarization modulator of FIG. 17. FIG. 17 illustrates an implementation of a passive polarization modulator (i.e., a way to modulate the polarization state of each pulse) via a passive delay line for use with a discrete-time coherent ranging system, where the upper left inset shows a series of pulses that are emitted from the source amplifier and subsequently input to the polarization modulator at two wavelengths λ₁ and λ₂ and the upper right inset shows a series of pulses that have been output from the polarization modulator to the sample size of the interferometer at the two wavelengths λ₁ and λ₂, where each input pulse is split into a pair of respective output pulses at different polarities.

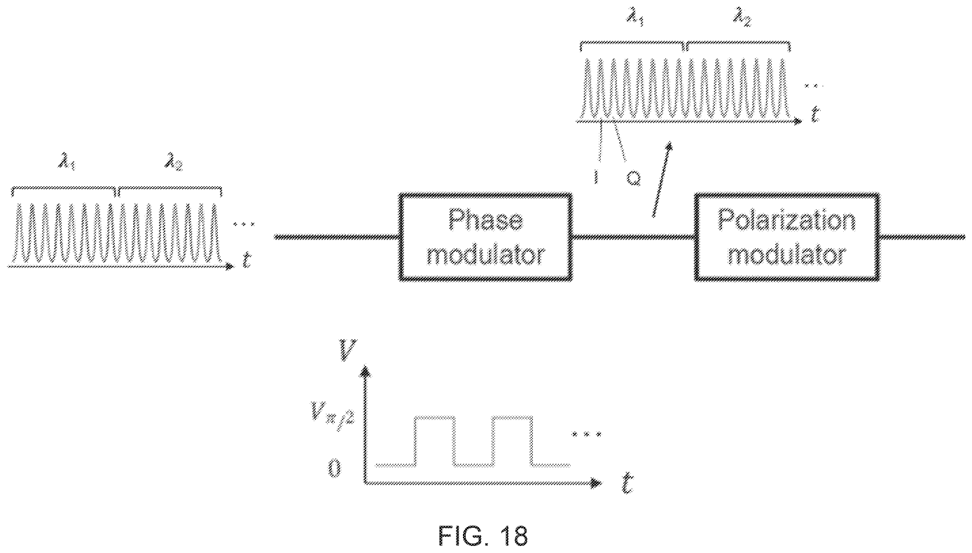

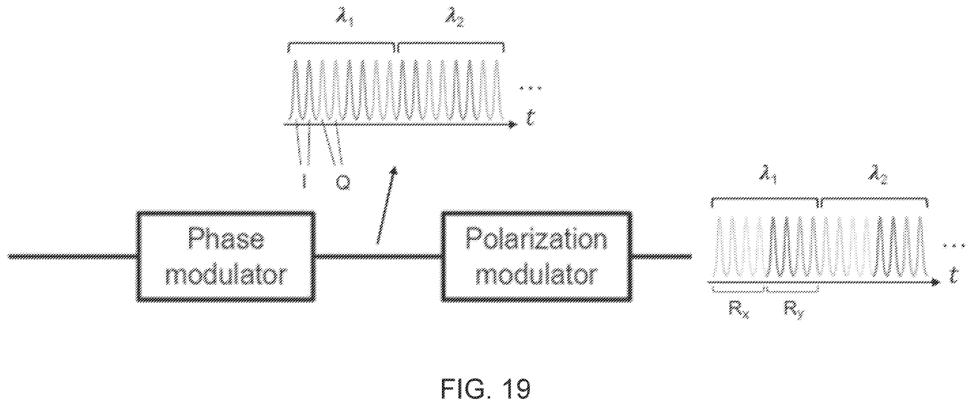

The system of FIG. 15 may also include an active phase and/or polarization modulator such as those illustrated in FIGS. 18 and 19. FIG. 18 illustrates phase modulation using an implementation of an active (e.g., controlled via a voltage-driven electro-optic modulator) phase and polarization modulator, which can be inserted into the setup in FIG. 15 as the “phase/polarization modulation circuit” (see “5. Signal modulation” portion of FIG. 15), where the input pulses at wavelengths λ₁ and λ₂ (left) are initially modulated by the phase modulator to produce in-phase (I) and quadrature (Q) pulses (top) under control of voltage signal V (bottom).

FIG. 19 illustrates polarization modulation using an implementation of an active (via a voltage-driven electro-optic modulator) phase and polarization modulator, which can be inserted into the setup in FIG. 15 as the “phase/polarization modulation circuit,” where the input pulses at wavelengths λ₁ and λ₂ (top) are in-phase (I) and quadrature (Q) pulses from a phase modulator as in FIG. 18, where the output pulses have polarities Rx and Ry (right), where Q is 90° shifted from I and Rₓ=x polarized and R_{y}=y polarized, and where the right panel of FIG. 19 illustrates the states of two sets of 8 pulses all of which are at the same wavelength.

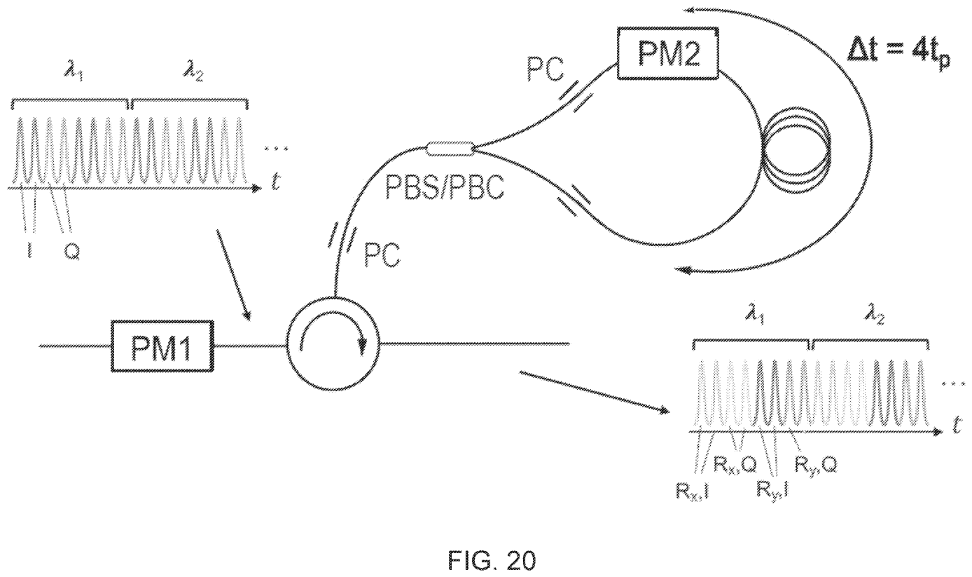

FIG. 20 illustrates a Sagnac interferometer based implementation of a polarization modulator in which a series of pulses (upper left) is produced after being transmitted through a phase modulator PM1 which is then polarized to produce the pulses shown in the lower right which have different wavelengths λ₁ and λ₂, different polarities Rₓ and R_{y}, and different phases I and Q. The Sagnac interferometer based implementation of FIG. 20 includes the phase modulator PM2 which is located asymmetrically within the Sagnac loop such that the CW and CCW pulse from a given input pulse see the phase modulator at different times and therefore can experience a different induced phase shift, leading to a polarization modulation of the output pulse. This design is advantageous because the DC drift of the phase modulator is removed by the Sagnac interferometer.

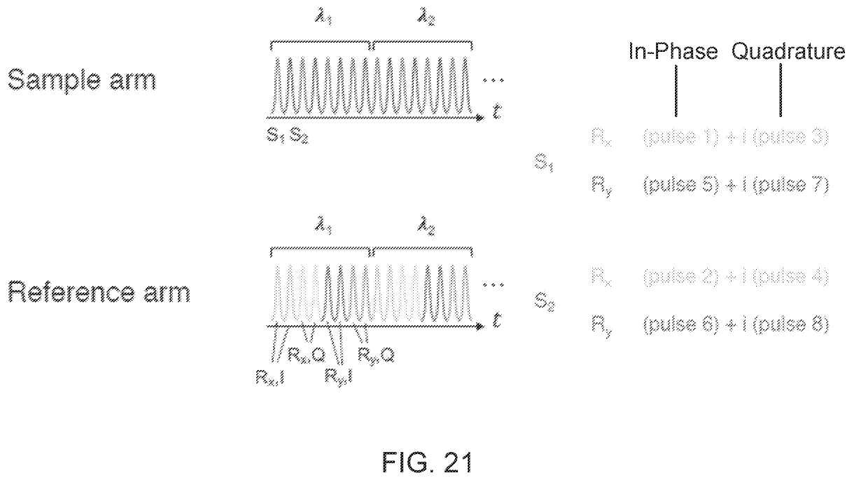

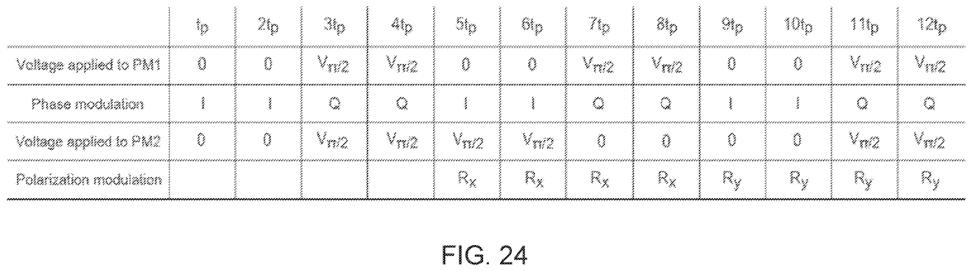

FIG. 21 shows the phase and polarization encoded pulses for a particular system at the end of the sample arm and reference arm, where the sample arm encoding (upper left) is achieved via the modulator shown in FIGS. 18-20 and the reference arm encoding (lower left) is achieved via the passive polarization modulator in FIG. 17. The text on the right hand side of FIG. 21 shows how the sample arm pulses S₁, S₂ shown in the upper left are combined with the reference arm pulses Rₓ, R_{y} shown in the lower left (see also FIG. 24).

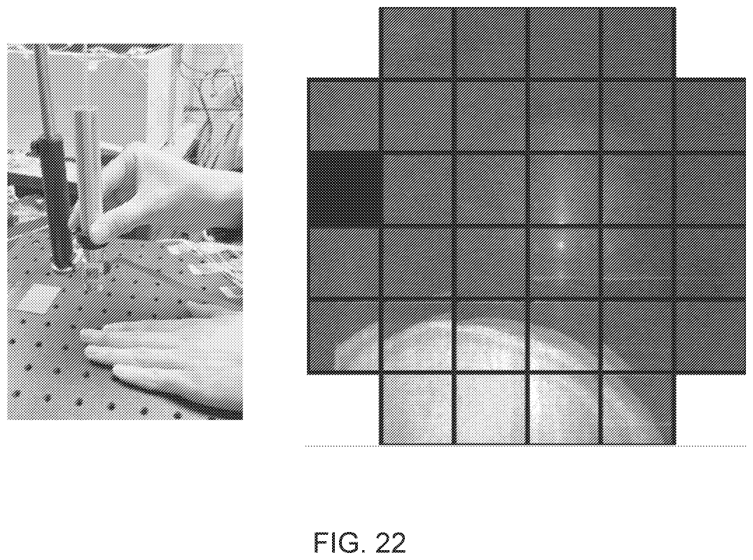

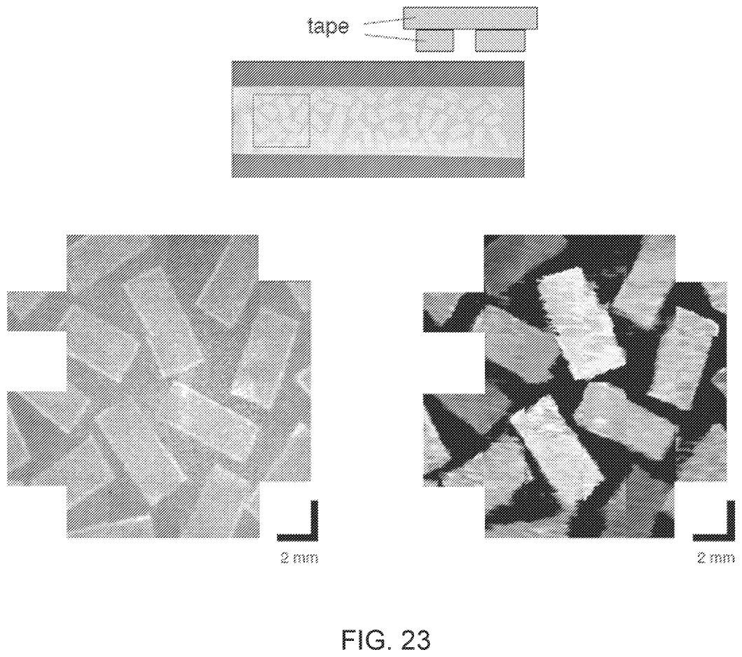

FIG. 22 shows a photograph of imaging of a fingertip/fingernail region using a discrete-time coherent ranging system according to the disclosure (left) and a structural OCT micrograph produced by the imaging (right).

FIG. 23 shows images of a phantom made from pieces of tape (top) showing the pieces of tape using structural (left) and polarization-sensitive (right) OCT imaging.

FIG. 24 illustrates the phase encoding scheme for the phase and polarization modulators described in FIGS. 18-21. The columns are time-slots of width equal to the optical pulse separation, so it shows the phase provided by each of the two modulators at each discrete time slot, and also shows the resulting phase I/Q and polarization state (Rₓ, R_{y}) that results at times tₚ, 2tₚ, 3tₚ, . . . , including the voltages applied to PM1 and PM2.

Thus, while the invention has been described above in connection with particular embodiments and examples, the invention is not necessarily so limited, and that numerous other embodiments, examples, uses, modifications and departures from the embodiments, examples and uses are intended to be encompassed by the claims attached hereto.

What is claimed is:

1. A coherent ranging system, comprising:
an electromagnetic radiation source;
a detector; and
optics comprising a sample arm and a reference arm,
the electromagnetic radiation source configured to generate a plurality of optical pulses and transmit the plurality of optical pulses toward the sample arm and the reference arm, and
the detector configured to receive electromagnetic radiation returned from the sample arm and the reference arm and to generate a plurality of values based on an optical energy of each of the plurality of optical pulses of the electromagnetic radiation returned from the sample arm and the reference arm,
each value of the plurality of values corresponding to a respective optical pulse of the plurality of optical pulses.

2. The system of claim 1, wherein each value of the plurality of values is independent of all other of the plurality of values.

3. The system of claim 1, wherein an optical energy of each value of the plurality of values is independent of an optical energy of each of the other of the plurality of values.

4. The system of any one of the preceding claims, wherein the plurality of values comprises a plurality of digital values, and
wherein each of the digital values is based on an amount of optical energy present in a respective optical pulse of the plurality of optical pulses.

5. The system of any one of the preceding claims, further comprising a processor configured to receive the plurality of values and generate structural information for a sample based on the plurality of values.

6. The system of any one of the preceding claims, wherein each of the plurality of values describes at least one of a phase quadrature, a polarization state, or a reflectivity of the sample to the electromagnetic radiation at a particular wavelength.

7. The system of any one of the preceding claims, wherein each optical pulse of the plurality of optical pulses has a duty cycle of less than 100%.

8. The system of any one of the preceding claims, wherein the plurality of optical pulses is transmitted at a respective plurality of time points, and
wherein at least one time point of the plurality of time points does not contain an optical pulse.

9. The system of any one of the preceding claims, wherein the detector comprises a balanced detector comprising a pair of inputs, and
wherein the balanced detector is further configured to receive electromagnetic radiation returned from the sample arm and the reference arm and to generate the plurality of values based on determining a difference in signals provided to the pair of inputs.

10. The system of claim 9, further comprising an optical modulator configured to modulate at least one of a phase or a polarization of the plurality of optical pulses.

11. The system of claim 10, wherein the optical modulator comprises at least one of a passive polarization modulator, a voltage-driven electro-optic modulator, or a Sagnac interferometer polarization modulator.

12. The system of claim 10, wherein the signals provided to the pair of inputs of the balanced detector comprise signals based on at least one of pairs of phase modulated optical pulses or pairs of polarization modulated optical pulses.

13. The system of any one of the preceding claims, wherein the detector is configured to generate the plurality of values based on an integration of the optical energy during a duration of each of the plurality of optical pulses.

14. The system of any one of the preceding claims, wherein each of the plurality of optical pulses comprises a pulse duration,
wherein the detector is further configured to have an analog bandwidth greater than a Nyquist limit based on the pulse duration, and
wherein each of the plurality of optical pulses includes at least one of:
a pulse width less than the pulse duration, or
a peak power that is at least twice an average power of the optical pulse.

15. The system of any one of claims 1-13, wherein each of the plurality of optical pulses is shaped to match a system response of the detector such that each value of the plurality of values is based substantially only on the optical energy of the respective optical pulse.

16. The system of any one of claims 1-13, wherein a value of the plurality of values corresponding to a pulse of the plurality of pulses is processed using a deconvolution algorithm to remove signal based on at least one of the other pulses of the plurality of pulses.

17. The system of any one of claims 1-13, wherein the detector is further configured to reset to a baseline after detecting each of the optical pulses.

18. The system of any one of the preceding claims, further comprising a controller coupled to the electromagnetic radiation source and the detector, wherein the controller is configured to control operation of the electromagnetic radiation source and the detector to coordinate a timing of generating the plurality of optical pulses with generating the plurality of values based on the plurality of optical pulses.

19. The system of any one of the preceding claims, wherein the detector comprises a first detector, and
wherein the system further comprises a second detector and a deinterleaver coupled to the first detector and the second detector,
wherein the deinterleaver is configured to direct a first pulse of the plurality of pulses to the first detector and a second pulse of the plurality of pulses to the second detector.

20. The system of any one of the preceding claims, wherein each of the plurality of pulses comprises a pulsewidth and a pulse duration, and
wherein the pulsewidth is shorter than the pulse duration such that a reflection of a pulse of the plurality of pulses off the optics is temporally separated from a reflection from a sample.

21. The system of any one of the preceding claims, wherein the optics comprise at least one of optical fibers or free space optics.

22. The system of any one of the preceding claims, wherein the optics comprise an optical coherence tomography (OCT) system.

23. A method for coherent ranging, comprising:
providing an electromagnetic radiation source, a detector, and optics comprising a sample arm and a reference arm;
generating, using the electromagnetic radiation source, a plurality of optical pulses and transmitting the plurality of optical pulses toward the sample arm and the reference arm;
receiving, using the detector, electromagnetic radiation returned from the sample arm and the reference arm; and
generating, using a processor coupled to the detector, a plurality of values based on an optical energy of each of the plurality of optical pulses of the electromagnetic radiation returned from the sample arm and the reference arm,
each value of the plurality of values corresponding to a respective optical pulse of the plurality of optical pulses.

24. The method of claim 23, wherein each value of the plurality of values is independent of all other of the plurality of values.

25. The method of claim 23, wherein an optical energy of each value of the plurality of values is independent of an optical energy of each of the other of the plurality of values.

26. The method of any one of claims 23-25, wherein the plurality of values comprises a plurality of digital values, and
wherein generating the plurality of values further comprises:
generating the plurality of digital values,
wherein each of the digital values is based on an amount of optical energy present in a respective optical pulse of the plurality of optical pulses.

27. The method of any one of claims 23-26, further comprising:
the processor receiving the plurality of values, and
generating structural information for a sample based on the plurality of values.

28. The method of any one of claims 23-27, wherein each of the plurality of values describes at least one of a phase quadrature, a polarization state, or a reflectivity of the sample to the electromagnetic radiation at a particular wavelength.

29. The method of any one of claims 23-28, wherein each optical pulse of the plurality of optical pulses has a duty cycle of less than 100%.

30. The method of any one of claims 23-29, wherein transmitting the plurality of optical pulses further comprises:
transmitting the plurality of optical pulses at a respective plurality of time points,
wherein at least one time point of the plurality of time points does not contain an optical pulse.

31. The method of any one of claims 23-30, wherein the detector comprises a balanced detector comprising a pair of inputs, and
wherein the method further comprises:
receiving, by the pair of inputs of the balanced detector, electromagnetic radiation returned from the sample arm and the reference arm, and
wherein generating the plurality of values further comprises:
generating the plurality of values based on determining a difference in signals provided to the pair of inputs.

32. The method of claim 31, further comprising:
modulating, using an optical modulator, at least one of a phase or a polarization of the plurality of optical pulses.

33. The method of claim 32, wherein the optical modulator comprises at least one of a passive polarization modulator, a voltage-driven electro-optic modulator, or a Sagnac interferometer polarization modulator.

34. The method of claim 32, wherein the signals provided to the pair of inputs of the balanced detector comprise signals based on at least one of pairs of phase modulated optical pulses or pairs of polarization modulated optical pulses.

35. The method of any one of claims 23-34, wherein generating the plurality of values further comprises:
generating the plurality of values based on an integration of the optical energy during a duration of each of the plurality of optical pulses.

36. The method of any one of claims 23-35, wherein each of the plurality of optical pulses comprises a pulse duration, and
wherein providing the detector further comprises:
providing the detector having an analog bandwidth greater than a Nyquist limit based on the pulse duration,
wherein each of the plurality of optical pulses includes at least one of:
a pulse width less than the pulse duration, or
a peak power that is at least twice an average power of the optical pulse.

37. The method of any one of claims 23-35, further comprising:
shaping each of the plurality of optical pulses to match a system response of the detector such that each value of the plurality of values is based substantially only on the optical energy of the respective optical pulse.

38. The method of any one of claims 23-35, further comprising:
processing a value of the plurality of values corresponding to a pulse of the plurality of pulses using a deconvolution algorithm to remove signal based on at least one of the other pulses of the plurality of pulses.

39. The method of any one of claims 23-35, further comprising:
resetting the detector to a baseline after detecting each of the optical pulses.

40. The method of any one of claims 23-39, further comprising:
controlling, using a controller coupled to the electromagnetic radiation source and the detector, operation of the electromagnetic radiation source and the detector to coordinate a timing of generating the plurality of optical pulses with generating the plurality of values based on the plurality of optical pulses.

41. The method of any one of claims 23-40, wherein the detector comprises a first detector,
wherein the method further comprises:
directing, using a deinterleaver, a first pulse of the plurality of pulses to the first detector and a second pulse of the plurality of pulses to a second detector.

42. The method of any one of claims 23-41, wherein each of the plurality of pulses comprises a pulsewidth and a pulse duration, and
wherein the pulsewidth is shorter than the pulse duration such that a reflection of a pulse of the plurality of pulses off the optics is temporally separated from a reflection from a sample.

43. The method of any one of claims 23-42, wherein the optics comprise at least one of optical fibers or free space optics.

44. The method of any one of claims 23-43, wherein the optics comprise an optical coherence tomography (OCT) system.
